(19) United States
(12) Patent Application Publication
(10) Pub. No.: US 2001/0010047 A1
(43) Pub. Date: Jul. 26, 2001

(54) Process, internet access device, exchange and charging device for charging for internet services

(76) Inventors: Yuzhong Shen, Stuttgart (DE); Heiko Breckel, Kirchheim (DE); Uwe Seckelmann, Korntal-Munchingen (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/748,020

(22) Filed: Dec. 27, 2000

(30) Foreign Application Priority Data
Jan. 13, 2000 (DE) 100 01 079.2

(51) Int. Cl. G06F 17/00

(52) U.S. Cl. 705/400

(57) ABSTRACT

The invention relates to a process, an Internet access device (POP), a charging device (ACC) and an exchange (SSP) for charging for Internet services by the Internet access device via which, by means of a terminal (TERA) connected to a telephone-telecommunications network (PSTN), a subscriber (SUBA) accesses the Internet (INT) with the aid of the telecommunications network. The terminal now establishes a connection to the access device via the telecommunications network, and the telecommunications network sends the access device a subscriber number assigned to the terminal. The terminal sends the access device a service request message which the access device forwards to an Internet service device (CO1, CO2) for the provision of the service. The access device determines a charge claim indicating charges for the provision of the service an sends a charging device (ACC) of the telecommunications network a charge message containing the subscriber number of the subscriber and an indication of the charges claimed in the charge claim for the use of the requested service. The charging device debits the indicated charges to an account of the subscriber.

### DESCRIPTION

The present invention relates to a process according to the preamble of claim 1 and to an Internet access device according to the preamble of claim 9 therefor, a charging device according to the preamble of claim 10 therefor, and an exchange with an Internet access device according to the preamble of claim 11 therefor.

When a typical end subscriber makes an online connection via his terminal, normally a personal computer, to a data network, in particular the Internet, he generally uses the services of a public telephone network, also known as the PSTN (Public Switched Telephone Network). The subscriber then connects his terminal via a modem to the subscriber line leading to his residence and on the terminal dials the number of an access device to the Internet. The public telephone network then establishes the connection between the terminal and the access device so that the subscriber is “online” with his terminal. The subscriber can then use Internet services via a so-called Internet service provider. Normally the subscriber thereby incurs on the one hand telephone charges for use of the telephone network, which are debited by the telephone network operator to a charge account of the subscriber, and on the other hand Internet charges for access to the Internet which are separately billed by the ISP. If however the subscriber wishes to use chargeable services of a so-called content provider, he must pay for these separately, for example by credit card payment or so-called micropayment. This inhomogeneous form of payment to different payees is highly inconvenient for the subscriber.

Therefore the object of the invention is to enable a subscriber who accesses the Internet from his terminal via a telephone-telecommunications network to pay in a convenient manner for charges incurred by the use of services offered via the Internet.

This object is achieved by a process according to the technical theory of claim 1, an Internet access device according to the technical theory of claim 9, a charging device according to the technical theory of claim 10 and an exchange according to the technical theory of claim 11. Further advantageous developments of the invention are disclosed in the dependent claims and the description. Combinations of the features of the claims are readily possible.

The invention is based on the principle that by means of a terminal, for example a personal computer, a subscriber firstly establishes an online connection to an Internet access device in known manner via a subscriber line of a public telecommunications network. The telephone-telecommunications network then sends the Internet access device a subscriber number assigned to the terminal or another code digit characterising the subscriber line so that the Internet access device can identify the subscriber. Following the input of a request for Internet services by the subscriber, the terminal sends a service request message to the Internet access device which the Internet access device forwards to an Internet service device, e.g. a server of a so-called Internet service provider (ISP) or a so-called content provider for the provision of the service. The Internet access device determines a charge claim indicating charges for the provision of the service for example by analyzing the service request message or obtaining a charge claim message from the Internet service device. The Internet access device then detects the charge claim and sends a charging device of the telephone-telecommunications network a charge message containing the subscriber number or other code digit of the subscriber and an indication at least of the charges claimed in the charge claim for the use of the requested service. The charging device then debits the charges indicated in the charge message to an account of the subscriber. These Internet charges can then be billed to the subscriber together with telephone charges incurred for the use of the telephone-telecommunications network so that the subscriber can pay in a very convenient way and is not required to settle separate invoices issued by different parties.

The principle of the invention is also superior to approaches in which an operator of the telephone-telecommunications network meters charges for an access connection to the Internet and bills these to the subscriber together with his telephone account. A part of the thus metered charges is then forwarded for example to an ISP. In contrast to the invention however, in such cases it is only possible for the telephone-telecommunications network to calculate the charges as a function of time during the existence of the access connection. In accordance with the invention however, the Internet access device can calculate charges not only as a function of the time for which Internet services are used but also as a function of the quantity and quality of the data retrieved from or sent to the Internet service device. Additionally the telephone-telecommunications network need only be insubstantially upgraded and is not burdened with charging, which in some cases requires a large outlay, as it is not the telephone-telecommunications network but the Internet access device which determines the charges and sends these for debiting to the anyhow provided charging device.

In accordance with the invention, the Internet access device and the Internet service device can also cooperate interactively to determine the charge claim in that for example the Internet service device sends the Internet access device a charge claim indicating charges for the provision of the service. Here the Internet service device can make the provision of the requested service dependent upon a transmission from the Internet access device to the Internet service device of a payment confirmation message with which the Internet access device confirms to the Internet service device that the charge message has been sent to the change metering device. The Internet access device is thus substantially relieved of the calculation of charges and, as it were, “certainty of payment” is assured for the Internet service device. Furthermore so-called electronic trade (e-commerce) can also be handled in this way. Payment by credit card, requiring viewable, unsecure transactions via the telephone-telecommunications network or the Internet, can be avoided.

Many Internet services are offered to subscribers only in return for payment by credit card. However not every subscriber possesses a credit card or is prepared to use his credit card for such a purpose, for example due to the above mentioned security risks. In such cases the Internet access device can make the payment by credit card in place of the subscriber and bill the subscriber in the manner already explained. For this purpose the Internet access device sends a payment consent message in which the Internet access device consents to a credit card payment, to the credit of the Internet service device, of charges claimed for a provision of a service.

The Internet access device can also make the transmission of the charge message to the charging device of the telephone-telecommunications network dependent upon the acknowledgement of a request message for a payment confirmation, sent from the Internet access device to the terminal, by the subscriber via a confirmatory input on his terminal and the subsequent transmission of a payment confirmation message from the terminal to the Internet access device. In this way the subscriber always retains control over his payments. To further increase the security and the subscriber's control over his payments, the terminal can send an authenticity code, given for example by the subscriber, to the Internet access device in encrypted or unencrypted form. The Internet access device then allows access to Internet services only when this authenticity code is present.

The charging device can debit the charges indicated in the charge message in addition to the charges incurred by the subscriber for the use of the telephone-telecommunications network so that it is unnecessary to keep a separate account for the charges for use of Internet services. However it is also possible for the charging device to debit the charges indicated in the charge message from a prepaid subscriber account so that the subscriber never exceeds a payment limit set by himself and the telephone-telecommunications network has the assurance that the charges will be actually paid.

In addition to the charges for the provision of the service, in the charge message to the charging device the Internet access device can also indicate charges for the transmission of the charge message and thus also bill charges for the operation of the charging according to the invention in a manner which is both convenient for the subscriber and attractive for the Internet access device operator.

In the following the invention and the advantages thereof will be described in the form of an exemplary embodiment making reference to the drawings in which:

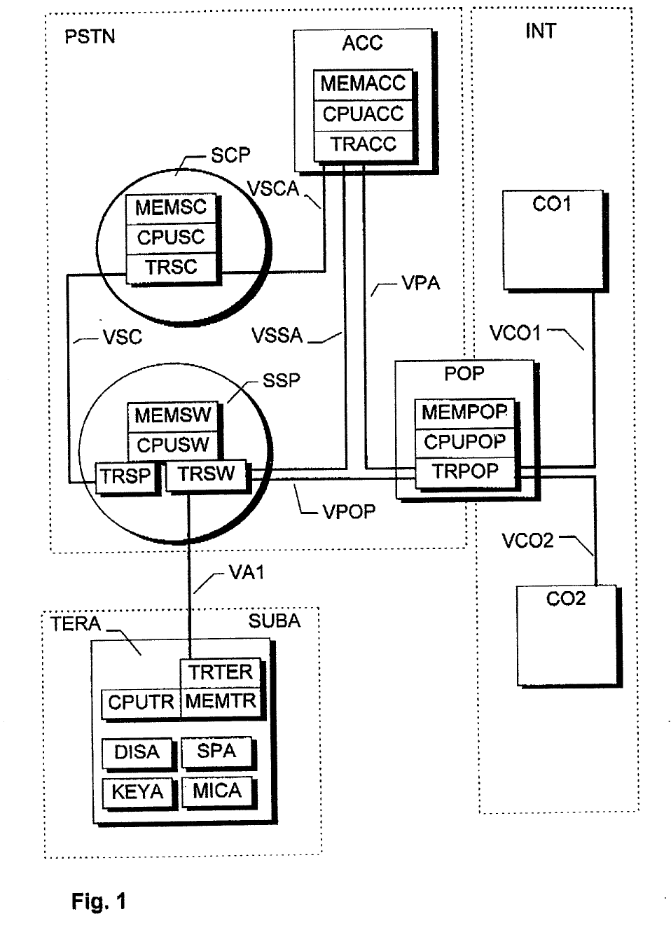

FIG. 1 illustrates an arrangement for the execution of the process according to the invention showing a terminal TERA and an exemplary embodiment in each case of an exchange SSP according to the invention, a charge computer ACC according to the invention and an Internet access device POP according to the invention and

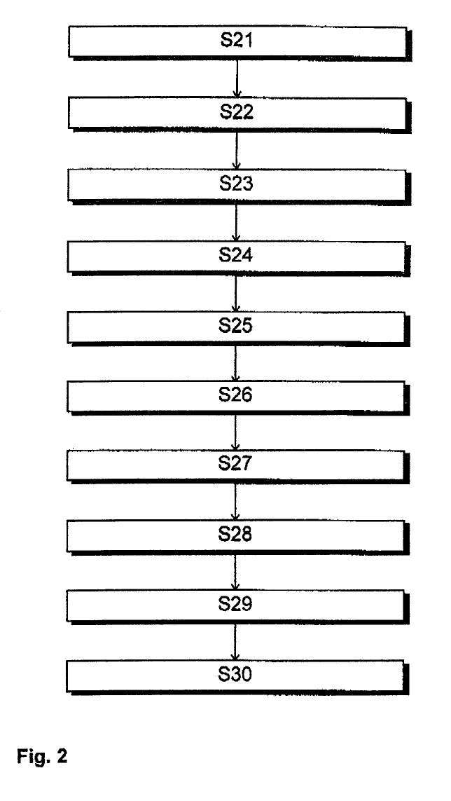

FIG. 2 is a flow diagram of the process according to the invention.

FIG. 1 illustrates an example of an arrangement with which the invention can be executed. FIG. 1 shows a telecommunications network PSTN and the Internet INT, in each case indicated by a dotted-line box. A subscriber SUBA indicated by another dotted-line box has a terminal TERA which is connected via a subscriber line VA1 to a service exchange SSP of the telecommunications network PSTN. Via the telecommunications network PSTN the subscriber SUBA can access the Internet INT by means of his terminal TERA.

The terminal TERA is preferably a personal computer equipped for connection to the Internet, but can also consist for example of a mobile phone or fixed-network phone suitable for Internet communication. The terminal TERA comprises a connection means TRTER consisting for example of a modem or an ISDN adapter. Via the connection means TRTER the terminal TERA can establish a connection to the Internet INT by means of the telecommunications network PSTN. The terminal TERA also comprises control means CPUTR and storage means MEMTR. The control means CPUTR consist for example of a processor with which program code, stored in the storage means MEMTR, can be executed. The storage means MEMTR consist for example of a hard disc or RAM modules. The terminal TERA also comprises a display means DISA and an input means KEYA. The display means DISA consist for example of a computer monitor or a LCD display (liquid crystal display). The input means KEYA can consist of a keyboard or a mouse. The terminal TERA also comprises a loudspeaker SPA and a microphone MICA facilitating speech output and speech input. Using program code stored in the storage means MEMTR and executable by the control means CPUTR, in particular a so-called browser, the terminal TERA functions as a terminal for Internet communication in which data editable by the browser is loaded from or sent to the Internet INT.

In the telecommunications network PSTN, which in the exemplary embodiment has the form of an intelligent network (IN), the exchange SSP, a service control node SCP and a charge computer ACC have been shown as representatives of further devices not illustrated in FIG. 1, e.g. exchanges, front-end equipment and connection lines. The exchange SSP is a so-called service switching point and the service control node SCP is a so-called service control point of an intelligent network. The basic functions of a service switching point and of a service control point are standardized by the ITU (International Telecommunication Union) and therefore need not be specified here. For reasons of clarity, FIG. 1 does not show other devices of the telecommunications network PSTN in the form of an intelligent network, such as for example the so-called service management point which manages services provided by the service control point SCP, and a so-called service creation environment with which services for an intelligent network can be created.

The exchange SSP and the service control point SCP are connected to one another via a connection VSC, while the service control point SCP and the charge computer ACC are connected to one another via a connection VSCA. The connections VSC and VSCA are connections which are preferably routed via a signalling channel or signalling network. Such a signalling network is for example the central signalling system No. 7.

A few essential components of the exchange SSP have been shown by way of example, namely connection means TRSW and TRSP and control means CPUSW and storage means MEMSW. With the connection means TRSW the exchange SSP can establish data- and voice connections to subscribers or other exchanges which have not been shown. With the connection means TRSP the exchange SSP can establish signalling connections, such as for example the connection VSC, to the service control point SCP. The control means CPUSW consist for example of a processor or group of processors which can execute commands stored in the storage means MEMSW. The control means CPUSW controls the functions of the exchange SSP and thus influences for example the functions of the connection means TRSW. The connection means TRSW, the control means CPUSW and the storage means MEMSW are interconnected by connections not shown in FIG. 1. Additionally the exchange SSP can comprise further assemblies, for example a switching network or an interface to a network management system. The exchange SSP can be a local exchange to which, in addition to the terminal TERA, further terminals which have not been shown are connected. However the exchange SSP can also be preceded by other devices which have not been shown, e.g. a local exchange or a front-end device to which the terminal TERA is then connected.

The service control point SCP comprises connection means TRSC, control means CPUSC and storage means MEMSC. The service control point SCP can be a server operated by a UNIX operating system or a Windows-NT operating system. The control means CPUSC consist of a processor or cluster of processors which executes the commands of the operating system stored in the memory MEMSC. The storage means MEMSC, which for example comprise a hard disc or RAM modules, can also store program code sequences which are executed by the control means CPUSC. The control means CPUSC also influence the functions of the connection means TRSC with which for example the forementioned connections VSC and VSCA can be established. The service control point SCP also comprises further assemblies not shown in FIG. 1, e.g. a monitor, keyboard and mouse. The service control point SCP provides services for the exchange SSP and also for other exchanges which have not been illustrated but are similarly equipped. Such a service is for example the known freecall service (telephone numbers commencing with “0800”).

The charge computer ACC is a charging device and is representative for example of further charge computers of the telecommunications network PSTN which have not been shown. The charge computer ACC debits charges for the use of the telecommunications network PSTN to accounts held by the charge computer ACC for subscribers connected to the telecommunications network PSTN. The charge computer ACC also holds such an account for the subscriber SUBA. Via a connection means TRACC of a transmitting and receiving assembly the charge computer ACC receives so-called charge tickets on a connection VSSA from the exchange SSP or on the connection VSCA from the service control point SCP. The charge tickets are messages indicating charges assigned to a subscriber number or a subscriber code digit. The charges indicated in the charge ticket are then debited by a control means CPUACC, which for example is a processor, to an account held for the subscriber number. The account is held for example in a database stored in a storage means MEMACC of the charge computer ACC. The storage means MEMACC consists for example of RAM modules and hard disc drives.

Of the Internet INT, only an Internet access device POP, a server CO1 and a server CO2 have been shown. The rest of the infrastructure of the Internet INT, for example servers, routers, gateways and the like, has not been shown in FIG. 1 for reasons of simplicity. The access device POP facilitates an access from the telecommunications network PSTN to the Internet INT. The servers CO1 and CO2 are computers via which an ISP or content provider offer Internet services, i.e. permit the loading of data from and into the Internet INT, offer interactive games and so on.

The access device POP comprises connection means TRPOP, control means CPUPOP and storage means MEMPOP. The access device POP can be a server which for example is operated by a UNIX operating system. The control means CPUPOP is a processor or cluster of processors which executes the commands of the operating system stored in the memory MEMPOP. The storage means MEMPOP, which for example comprise a hard disc or RAM modules, can also store program code sequences which are executed by the control means CPUPOP. The control means CPUPOP also influence the functions of the connection means TRPOP with which for example a connection VPOP can be established to the exchange SSP, a connection VPA to the charge computer ACC, a connection VCO1 to the server CO1 and a connection VCO2 to the server CO2. The access device POP also comprises further assemblies not shown in FIG. 1, e.g. a monitor, a keyboard and a mouse.

In the following a typical process flow will now be illustrated on the basis of the arrangement shown in FIG. 1 with reference to the flow diagram of FIG. 2.

In a step S21, via his terminal TERA the subscriber SUBA establishes a connection to the access device POP of the Internet INT. For this purpose the subscriber SUBA inputs a call number of the access device POP via the input means KEYA. Via the subscriber line VA1 the terminal TERA then establishes a connection to the exchange SSP. With the aid of the call number of the access device POP the exchange SSP then completes the desired connection of the subscriber SUBA and at the same time establishes the further connection VPOP1 to the access device POP. The call number of the access device POP can also however be an IN call number, thus a logical number. In this case the exchange SSP sends the service control point SCP a service request message containing the “logical” call number, to which the service control point SCP responds with a service message to the access device POP containing the physical call number required to establish the connection VPOP.

In a step S22 the telecommunications network PSTN sends a subscriber number, assigned to the terminal TERA, to the access device POP. The exchange SSP now transmits for example a calling line identifier (CLI) received from the terminal TERA. As however CLI forwarding by the exchange SSP is not always permitted, for example because this has been specified by the subscriber SUBA, the exchange SSP can also enquire of the service control point SCP whether forwarding is permitted. However it is also possible for the service control point SCP to instruct the exchange SSP to send the access device POP another code digit assigned to and identifying the subscriber SUBA instead of the CLI. It can also be specified that an authenticity code must be sent from the terminal TERA to the access device POP in encrypted or unecrypted form so that only the subscriber SUBA can apply to the access device as entitled to chargeable access to the Internet INT.

In a step S23 the terminal TERA sends a service request message to the access device POP. Depending upon whom this service request message is addressed to, in a step S24 the access device POP sends the service request message to the server CO1 or the server CO2. In the present case the service request message is directed to the server CO1.

In a step S25 the server CO1 then sends a charge claim, indicating charges for the provision of the service requested in the service request message, to the access device POP, which in the exemplary embodiment firstly stores the charge claim in its storage means MEMPOP. It is also possible for the access device POP to determine the charge claim by analyzing the charge claim message directed to the server CO1; for example it may determine the charge claim from predetermined costs of a service requested in the service request message. If a cost-free Internet service is requested in the service request message, the access device POP is “transparent” for the data sent upon the provision of the service and determines no charges. It is also possible for the access device POP to analyze the data sent upon the provision of the Internet service requested in the service request message and to determine a charge claim therefrom.

When a service request message is directed to the server CO2, the access device POP can determine charges in the same way. The subscriber is thus independent of any contractual agreements with operators of the servers CO1 or CO2.

In an optional step S26 the access device POP sends a request message for a payment confirmation to the terminal TERA. Not until, in a step S27, the subscriber SUBA has agreed to payment via an input on the input means KEYA does the terminal TERA send a payment confirmation message to the access device POP.

In an optional step S28, on the connection VPA the access device POP sends the server CO1 a payment confirmation message with which the access device POP confirms to the server CO1 that the charge message has been sent to the charge computer ACC. The server CO1 can thus make the provision of the requested Internet service dependent upon the receipt of a valid payment.

In a step which has not been illustrated, the server CO1 provides the requested service and the data to be thereby transmitted are transferred between the terminal TERA and the server CO1 by the access device POP.

In a step S29 the access device POP sends the charge computer ACC a charge message, also known as “ticket”, containing the subscriber number of the subscriber SUBA and an indication at least of the charges claimed in the charge claim for the use of the requested service. The charge message can have a format specially defined for the communication between the access device POP and the charge computer ACC or can be a so-called call ticket as conventionally used for the charging of call connections on the telecommunications network PSTN. In a step S30 the charge computer ACC then debits the charges indicated in the charge message to an account of the subscriber SUBA, to which the charges incurred for the use of the telecommunications network PSTN or for the use of IN services can also be debited. In the charge message the access device POP can additionally indicate charges claimed by the access device POP for its service provision.

The access device POP can combine a plurality of charge claims in one charge message or can also send each charge claim so-to-speak online to the charge computer ACC, in each case one charge message for each request for an Internet service by the terminal TERA.

The charge computer ACC can also debit the charges indicated in the charge message sent by the access device POP to an account which the subscriber SUBA has previously replenished with a payment amount. For the prepayment, cooperation takes place between the service control point SCP and the exchange SSP, and possibly a service management point (SMP) not shown in FIG. 1. For this purpose, via his terminal TERA the subscriber SUBA establishes a connection to the service control point SCP via the subscriber line VA1, the exchange SSP and the connection VSC. In interaction with the service control point SCP—or the SMP which has not been shown—the terminal TERA now sends the service control point SCP a confirmation of payment of the debited amount, which for example is debited to a credit card of the subscriber SUBA or a chip card read-in by the terminal TERA. The service control point SCP then sends a message to the charge computer ACC with which the account is replenished by the debited amount.

It is also possible for the access device POP to be integrated in the exchange SSP. In this case the storage means MEMSW and MEMPOP, the control means CPUSW and CPUPOP and the connection means TRSW and TRPOP can have the form of separate modules, or the control means CPUSW additionally fulfil the functions of the control means CPUPOP, the storage means MEMSW those of the storage means MEMPOP, and the connection means TRSW those of the connection means TRPOP. The connection VPOP is then an internal connection in the exchange SSP.

The charge computer ACC can also be integrated in the exchange SSP or the access device POP. Then the control means CPUSW and the control means CPUPOP fulfil the functions of the control means CPUACC, the storage means MEMSW and the storage means MEMPOP fulfil the functions of the storage means MEMACC, and the connection means TRSW and the connection means TRPOP fulfil the functions of the connection means TRACC. The connections VSSA and VPA are then internal connections in the exchange SSP and in the access device POP.

1. A process for charging for Internet services by an Internet access device (POP) via which, by means of a terminal (TERA) connected via a subscriber line (VA1) to a telephone-telecommunications network (PSTN), a subscriber (SUBA) access is granted to the Internet (INT) with the aid of the telephone-telecommunications network (PSTN), comprising the following steps:
the terminal (TERA) establishes a connection (VA1, VPOP) to the Internet access device (POP) via the telephone-telecommunications network (PSTN),
the telephone-telecommunications network (PSTN) sends the Internet access device (POP) a subscriber number assigned to the terminal (TERA),
the terminal (TERA) sends a service request message to the Internet access device (POP) which the Internet access device (POP) forwards to an Internet service device (CO1, CO2) for the provision of the service,
the Internet access device (POP) determines a charge claim indicating charges for the provision of the service,
the Internet access device (POP) sends a charging device (ACC) of the telephone-telecommunications network (PSTN) a charge message containing the subscriber number of the subscriber (SUBA) and an indication at least of the charges claimed in the charge claim for the use of the requested service,
the charging device (ACC) debits the charges indicated in the charge message to an account of the subscriber.

2. A process according to claim 1, characterised in that the Internet service device (CO1, CO2) communicates to the Internet access device (POP) a charge claim indicating charges for the provision of the service.

3. A process according to claim 1, characterised in that the Internet access device (POP) sends the Internet service device (CO1, CO2) a payment confirmation message with which the Internet access device (POP) confirms to the Internet service device (CO1, CO2) that the charge message has been sent to the charging device (ACC).

4. A process according to claim 1, characterised in that the Internet access device (POP) sends the terminal (TERA) a request message for a payment confirmation, that the terminal (TERA) detects an input by the subscriber (SUBA) agreeing to the payment, and that following the detection of the agreeing input the terminal (TERA) sends a payment confirmation message to the Internet access device (POP).

5. A process according to claim 1, characterised in that the Internet service device (CO1, CO2) communicates to the Internet access device (POP) a charge claim indicating charges for the provision of the service, and that the Internet service device (CO1, CO2) sends a payment consent message with which the Internet access device (POP) consents to a payment, in particular by credit card, to the credit of the Internet service device (CO1, CO2).

6. A process according to claim 1, characterised in that the charging device (ACC) debits the charges indicated in the charge message from a prepaid account of the subscriber (SUBA).

7. A process according to claim 1, characterised in that in the charge message to the charging device (ACC) the Internet access device (POP) indicates charges for the transmission of the charge message in addition to the charges for the provision of the service.

8. A process according to claim 1, characterised in that the terminal (TERA) sends an authenticity code to the Internet access device (POP) in encrypted or unencrypted form.

9. An Internet access device (POP) for charging for Internet services wherein, by means of a terminal connected via a subscriber line (VA1) to a telephone-telecommunications network (PSTN), a subscriber (SUBA) is connected to the Internet (INT) via the telephone-telecommunications network (PSTN) and the Internet access device (POP), characterised in that the Internet access device (POP) comprises receiving means (TRPOP, CPUPOP, MEMPOP) which are designed such that the Internet access device (POP) can receive a subscriber number transmitted by the telephone-telecommunications network (PSTN) and assigned to the terminal (TERA), that the receiving means (TRPOP, CPUPOP, MEMPOP) are further designed such that the Internet access device (POP) can receive a service request message transmitted by the terminal (TERA), that the Internet access device (POP) comprises transmitting means (TRPOP, CPUPOP, MEMPOP) which are designed such that the Internet access device (POP) can forward the service request message to an Internet service device (CO1, CO2) for the provision of the service, that the Internet access device (POP) comprises charging means (CPUPOP, MEMPOP) which are designed such that the Internet access device (POP) can determine a charge claim indicating charges for the provision of the service, and that the transmitting means (TRPOP, CPUPOP, MEMPOP) are further designed such that the Internet access device (POP) can send a charging device (ACC) of the telephone-telecommunications network (PSTN) a charge message containing the subscriber number of the subscriber (SUBA) and an indication at least of the charges claimed in the charge claim for the use of the requested service.

10. A charging device (ACC) for charging for Internet services wherein, by means of a terminal (TERA) connected via a subscriber line (VA1) to a telephone-telecommunications network (PSTN), a subscriber (SUBA) is connected to the Internet (INT) via the telephone-telecommunications network (PSTN) and via an Internet access device (POP), characterised in that the charging device (ACC) comprises receiving means (TRACC) which are designed such that the charging device (ACC) can receive from the Internet access device (POP) a charge message containing a subscriber number of the subscriber (SUBA) and an indication at least of the charges claimed in a charge claim for the use of a service requested by the subscriber (SUBA) from an Internet service device (CO1, CO2) via the Internet access device (POP), and that the charging device (ACC) comprises accounting means (CPUACC, MEMACC) which are designed such that the charging device (ACC) can debit the charges indicated in the charge message to an account of the subscriber (SUBA).

11. An exchange with an Internet access device (POP) for charging of Internet services wherein, by means of a terminal (TERA) connected via a subscriber line (VA1) to a telephone-telecommunications network (PSTN), a subscriber (SUBA) is connected to the Internet (INT) via the telephone telecommunications network (PSTN) and via the Internet access device (POP), characterised in that the Internet access device (POP) comprises receiving means (TRPOP, CPUPOP, MEMPOP) which are designed such that the Internet access device (POP) can receive a subscriber number transmitted by the telephone-telecommunications network (PSTN) and assigned to the terminal (TERA), that the receiving means (TRPOP, CPUPOP, MEMPOP) are further designed such that the Internet access device (POP) can receive a service request message transmitted by the terminal (TERA), that the Internet access device (POP) comprises transmitting means (TRPOP, CPUPOP, MEMPOP) which are designed such that the Internet access device (POP) can forward the service request message to an Internet service device (CO1, CO2) for the provision of the service, that the Internet access device (POP) comprises charging means (CPUPOP, MEMPOP) which are designed such that the Internet access device (POP) can determine a charge claim indicating charges for the provision of the service, that the transmitting means (TRPOP, CPUPOP, MEMPOP) are further designed such that the Internet access device (POP) can send a charging device (ACC) of the telephone-telecommunications network (PSTN) a charge message containing the subscriber number of the subscriber (SUBA) and an indication at least of the charges claimed in the charge claim for the use of the requested service.
